(19) United States
(12) Patent Application Publication
(10) Pub. No.: US 2017/0276097 A1
(43) Pub. Date: Sep. 28, 2017

(54) FUEL REFORMER FOR VEHICLE ENGINE

(71) Applicant: Hyundai Motor Company, Seoul (KR)

(72) Inventors: Hong Kil BAEK, Seoul (KR); Seung Woo LEE, Seoul (KR); Tae Won LEE, Incheon (KR)

(73) Assignee: Hyundai Motor Company, Seoul (KR)

(21) Appl. No.: 15/351,964

(22) Filed: Nov. 15, 2016

(30) Foreign Application Priority Data
Mar. 22, 2016 (KR) 10-2016-0034255

(51) Int. Cl. F02M 27/02; C10L 3/00; C01B 3/38; F02M 35/024

(52) U.S. Cl. CPC F02M 27/02; F02M 35/024; C10L 3/00; C01B 3/386; C01B 3/38; C10L 2290/24; C10L 2290/143; C01B 2203/0261; C01B 2203/0233

(57) ABSTRACT

A fuel reformer for a vehicle engine may include a housing including an inlet at a first end and an outlet at a second end of the housing through which exhaust gas flows, a reforming catalyst disposed between the inlet and the outlet to reform exhaust gas, a mixing chamber providing a space for mixing fluid between the inlet and the reforming catalyst, a fuel injector injecting a same fuel to be supplied to the engine into the mixing chamber, and an air injector coupled to the housing to supply air into the mixing chamber.

### CROSS REFERENCE TO RELATED APPLICATION

The present application claims priority to Korean Patent Application No. 10-2016-0034255, filed Mar. 22, 2016, the entire contents of which is incorporated herein for all purposes by this reference.

### BACKGROUND OF THE INVENTION

Field of the Invention

The present invention relates to a fuel reformer for a vehicle engine and, more particularly, to a structure of a fuel reformer that can reform fuel and supply it to an engine, such as a gasoline engine, that is mounted in an engine room of a vehicle.

Description of Related Art

Hydrogen (H₂) quickly propagates flame and generates a large low heating value in comparison to gasoline, so when gasoline is burned with hydrogen, it is possible to substantially reduce the problem of knocking or unstable combustion that may be generated when the compression ratio of an engine is increased, and accordingly, it is possible to remarkably reduce the problem of knocking or unstable combustion that may occur when the compression ratio of an engine is increased, and accordingly, to provide a technical basis for improving the fuel efficiency of an engine.

Accordingly, there is a need for a technology for supplying hydrogen to an engine along with gasoline, but there are problems with this technology in that a specific amount of space and a specific device are required to mount a specific fuel tank in a vehicle, and it is additionally required to continuously supply hydrogen, as well as fuel, to a vehicle from the outside.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a fuel reformer for a vehicle engine that is mounted in the engine room of a vehicle having an engine and can maximize the performance of the engine with a relatively inexpensive and simple configuration by continuously supplying hydrogen to the engine even without being supplied with hydrogen from outside the vehicle by reforming some of the fuel that is supplied to the engine.

According to various aspects of the present invention, a fuel reformer for a vehicle engine may include a housing including an inlet at a first end and an outlet at a second end of the housing through which exhaust gas flows, a reforming catalyst disposed between the inlet and the outlet to reform exhaust gas, a mixing chamber providing a space for mixing fluid between the inlet and the reforming catalyst, a fuel injector injecting a same fuel to be supplied to the engine into the mixing chamber, and an air injector coupled to the housing to supply air into the mixing chamber.

The housing may be cylindrically formed between the first end having the inlet, and the second end having the outlet, and the reforming catalyst may be formed in a cylindrical shape disposed in a same direction in the housing.

The mixing chamber may provide a space continuously extending at an upstream side from a space where the reforming catalyst is disposed, and the fuel injector may be disposed opposite to the reforming catalyst, with the mixing chamber disposed between the fuel injector and the reforming catalyst, to inject fuel into the mixing chamber.

The exhaust gas flowing into the mixing chamber through the inlet and the fuel injected into the mixing chamber from the fuel injector may form an acute angle.

A filter, an air pump, and an air tank may be sequentially connected to the air injector, for air in the air tank to be filtered through the filter and then supplied to the air injector when the air pump is operated.

A compressed air tank may be connected to the air injector for air in the compressed air tank to be injected into the mixing chamber through the air injector when the air injector is operated.

According to various embodiments of the present invention, a fuel reformer for a vehicle engine is mounted in the engine room of a vehicle having an engine and can maximize the performance of the engine with a relatively inexpensive and simple configuration by continuously supplying hydrogen to the engine even without being supplied with hydrogen from outside the vehicle by reforming some of the fuel that is supplied to the engine.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a fuel reformer for a vehicle engine according to various embodiments of the present invention.

FIG. 2 is a view showing an example of applying the fuel reformer of various embodiments of the present invention to an engine of a vehicle.

FIG. 3 is a view showing a fuel reformer for a vehicle engine according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

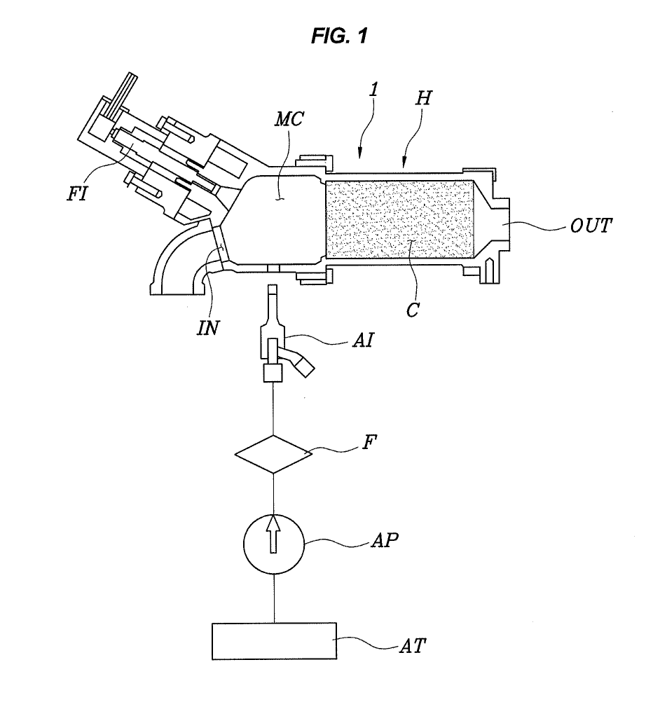

Referring to FIG. 1, a fuel reformer 1 for a vehicle engine according to various embodiments of the present invention includes a housing H having an inlet IN at a first end, and an outlet OUT at a second end through which exhaust gas can flow, a reforming catalyst C disposed between the inlet IN and the outlet OUT to reform the exhaust gas, a mixing chamber MC providing a space for mixing fluid between the inlet IN and the reforming catalyst C, a fuel injector FI injecting fuel, which is the same as that to be supplied to the engine, into the mixing chamber MC, and an air injector AI coupled to the housing H to supply air into the mixing chamber MC.

That is, exhaust gas and fuel are supplied and mixed in the mixing chamber MC of the housing H, after which the mixture is reformed through the reforming catalyst C and supplied into a combustion chamber of an engine, such that, when air is supplied by the air injector AI for a smoother reforming chemical reaction using the reforming catalyst C, the mixture of exhaust gas and fuel is more efficiently reformed with the air added through the reforming catalyst C.

The housing H is formed in a cylindrical shape between the first end, having the inlet IN, and the second end, having the outlet OUT, and the reforming catalyst C is formed in a cylindrical shape disposed in the same direction in the housing H.

The mixing chamber MC provides a space continuously extending on the upstream side from a space where the reforming catalyst C is disposed and the fuel injector FI is disposed opposite to the reforming catalyst C with the mixing chamber MC therebetween to inject fuel into the mixing chamber MC.

The exhaust gas flowing into the mixing chamber MC through the inlet IN and the fuel injected into the mixing chamber MC from the fuel injector FI form an acute angle.

Accordingly, the exhaust gas supplied into the mixing chamber MC through the inlet IN and the fuel injected from the fuel injector FI are naturally mixed in the mixing chamber MC with the air supplied from the air injector AI, reformed through the reforming catalyst C, and then discharged to the outlet OUT.

In various embodiments, the reforming catalyst C is a catalyst that can catalyze partial oxidation.

Partial oxidation, which is expressed by CmHn+O2->H2+CO (where m and n are natural numbers), represents a reaction in which CmHn that is a fuel component is reformed into hydrogen H2 by reacting with oxygen (O2).

That is, the air supplied from the air injector AI additionally supplies oxygen, so the reforming facilitated by the reforming catalyst C is improved.

In various embodiments, the reforming catalyst C may further perform stream reforming. Stream reforming, which is expressed by CmHn+H2O->H2+CO (where m and n are natural numbers), represents a reaction in which CmHn that is a fuel component is reformed into hydrogen H2 by reacting with vapor (H2O).

In various embodiments shown in FIG. 1, a filter F, an air pump P, and an air tank AT are sequentially connected to the air injector AI, so when the air pump AP is operated, the air in the air tank AT is filtered through the filter F and then supplied to the air injector AI.

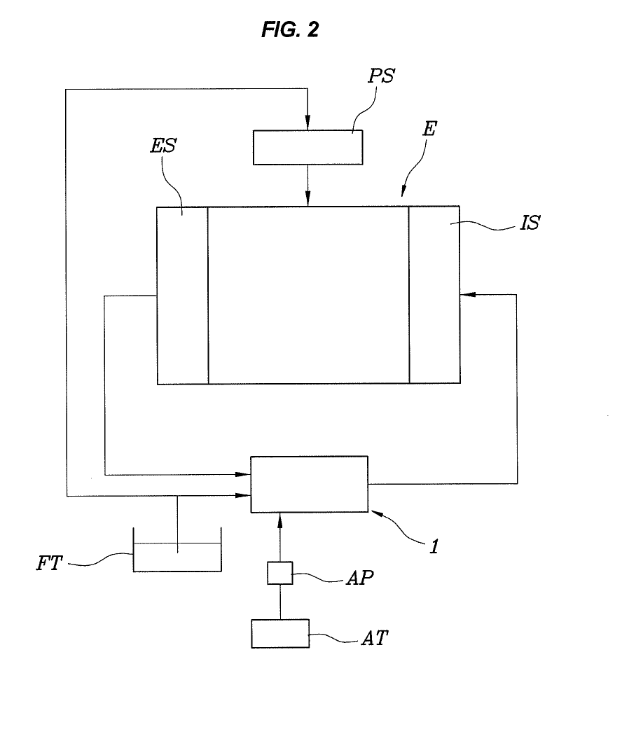

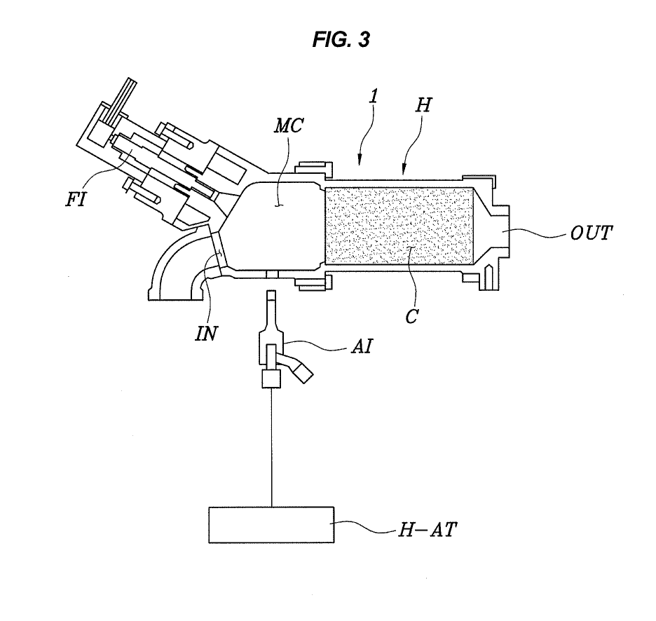

In various embodiments, a compressed air tank H-AT may be connected to the air injector AI as a source for supplying air to the air injector AI, as shown in FIGS. 2 and 3, in order that when the air injector AI is operated, the air in the compressed air tank H-AT can be injected into the mixing chamber MC through the air injector AI.

Accordingly, air is compressed and kept in the compressed air tank H-AT such that air can be injected into the mixing chamber MC, and it is possible to use a well-known technology such as a compressor in order to compress and store the air in the compressed air tank H-AT.

FIG. 2 shows the case when the fuel reformer 1 for a vehicle of various embodiments of the present invention shown in FIG. 1 is applied to an engine, in which, as described above, the fuel reformer 1 receives exhaust gas from an exhaust system ES of an engine and also receives fuel supplied from a fuel tank FT to a fuel supplier PS such as an injector of an engine E, and reforms and then supplies it to an intake system IS of the engine E. The air in the air tank AT is pumped by the air pump AP and then supplied to the fuel reformer 1 by the air injector AI, so the fuel can be more efficiently reformed.

Obviously, the fuel reformed in hydrogen is supplied to the engine E, so the compression ratio of the fuel is improved, and accordingly, the fuel efficiency of the engine can be considerably improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel reformer for a vehicle engine, comprising:
a housing including an inlet at a first end and an outlet at a second end of the housing through which exhaust gas flows;
a reforming catalyst disposed between the inlet and the outlet to reform exhaust gas;
a mixing chamber providing a space for mixing fluid between the inlet and the reforming catalyst;
a fuel injector injecting a same fuel to be supplied to the engine into the mixing chamber; and
an air injector coupled to the housing to supply air into the mixing chamber.

2. The fuel reformer of claim 1, wherein
the housing is cylindrically formed between the first end having the inlet, and the second end having the outlet; and
the reforming catalyst is formed in a cylindrical shape disposed in a same direction in the housing.

3. The fuel reformer of claim 1, wherein the mixing chamber provides a space continuously extending at an upstream side from a space where the reforming catalyst is disposed, and
the fuel injector is disposed opposite to the reforming catalyst, with the mixing chamber disposed between the fuel injector and the reforming catalyst, to inject fuel into the mixing chamber.

4. The fuel reformer of claim 3, wherein the exhaust gas flowing into the mixing chamber through the inlet and the fuel injected into the mixing chamber from the fuel injector form an acute angle.

5. The fuel reformer of claim 1, wherein a filter, an air pump, and an air tank are sequentially connected to the air injector, for air in the air tank to be filtered through the filter and then supplied to the air injector when the air pump is operated.

6. The fuel reformer of claim 1, wherein a compressed air tank is connected to the air injector for air in the compressed air tank to be injected into the mixing chamber through the air injector when the air injector is operated.
